(19) United States
(12) Patent Application Publication
(10) Pub. No.: US 2006/0215388 A1
(43) Pub. Date: Sep. 28, 2006

(54) Surface illuminator and liquid crystal display having the same

(76) Inventor: Tetsuya Hamada, Kanagawa (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(21) Appl. No.: 11/375,272

(22) Filed: Mar. 14, 2006

(30) Foreign Application Priority Data
Mar. 22, 2005 (JP) 2005-081240

(51) Int. Cl. G01D 11/28

(52) U.S. Cl. 362/29

(57) ABSTRACT

The invention relates to a surface illuminator and a liquid crystal display having the same and provides a low-cost surface illuminator and a liquid crystal display having the same. A liquid crystal display includes a liquid crystal display panel provided by sealing a liquid crystal between a pair of substrates and a backlight unit serving as a surface illuminator. The backlight unit has a light exit surface from which light in a color reproduction range defined by a plurality of chromaticities exit, a light guide having a light guide region for guiding light to the light exit surface, an LED light source having a first group of light sources emitting light having a wavelength shorter than a desired wavelength toward the light guide region and a second group of light sources emitting light having a wavelength longer than the desired wavelength, and a light source driving circuit having first and second driving portions for driving the first and second groups of light sources.

### BACKGROUND OF THE INVENTION

1. Field of the Invention

The present invention relates to a surface illuminator and a liquid crystal display having the same.

2. Description of the Related Art

FIGS. 10A and 10B show a schematic structure of a liquid crystal display 101 having a backlight unit 106 as a surface illuminator according to the related art. FIG. 10A is an exploded perspective view of the liquid crystal display 101, and FIG. 10B is a view of the backlight unit 106 taken from a light emitting side thereof. As shown in FIG. 10A, the liquid crystal display 101 includes a liquid crystal display panel 102 provided by sealing a liquid crystal between a pair of substrates and the backlight unit 106 serving as a surface illuminator.

The backlight unit 106 has a light guide 111 constituted by a transparent member in the form of a rectangular thin plate having a predetermined thickness. The light guide 111 has a light exit region (hereinafter referred to as light exit surface) 116 which spreads in the form of a plane on a side thereof facing the liquid crystal display panel 102 to allow light to exit. A surface of the light guide 111 opposite to the light exit surface 116 is a light scattering surface on which scattering dots (not shown) serving as a light output portion are printed. A reflective sheet 122 is provided on the light scattering surface of the light guide 111 opposite to the light exit surface 116.

A region of the light guide 111 sandwiched between the light exit surface 116 and the light scattering surface opposite thereto constitutes a light guide region for guiding light to the light exit surface 116. Among four side portions surrounding the peripheries of the light exit surface 116 and the light scattering surface, two side surfaces opposite to each other, e.g., the side surfaces along the longer sides of the light guide constitute light entrance surfaces through which light enters the light guide region.

LED light sources 115 which are arrays of discrete light sources are provided on the light entrance surfaces of the light guide 111. As shown in FIG. 10B, the LED light sources 115 include a plurality of R-emission LEDs (R) emitting in red, a plurality of G-emission LEDs (G) emitting in green, and a plurality of B-emission LEDs (B) emitting in blue. The LEDs (R), (G), and (B) are provided substantially in line along the light entrance surfaces. Reflectors (reflective plates) 120 (not shown in FIG. 10B) are provided around the LED light sources 115 to allow light from the LED light sources 115 to enter the light guide 111 efficiently.

A diffusing sheet 103 and two lens sheets 104 and 105 are provided in the order listed between the light guide 111 and the liquid crystal display panel 102. As thus described, the backlight unit 106 has a configuration in which the reflective sheet 112, the light guide 111, the diffusing sheet 103, and the two lens sheets 104 and 105 are provided one over another in the order listed.

Since beams of light emitted by the R-emission LEDs (R), G-emission LEDs (G), and the B-emission LEDs (B) are subjected to color mixing in the light guide 111, the backlight unit 106 is capable of emitting white light. A color filter is provided at each pixel of the liquid crystal display panel 102. The chromaticity of each of red light (R light), green light (G light), and blue light (B light) transmitted by the liquid crystal display panel 102 is determined substantially by the combination of the emission spectrum of the light emitted from the backlight unit 106 and the transmission characteristics of the color filters of the liquid crystal display panel 102 associated therewith. There are various standards for a color reproduction range including NTSC and adobeRGB, and the liquid crystal display 101 is designed to achieve sufficient matching between the emission spectrum of each of the LEDs (R), (G), and (B) and the transmission characteristics of the color filters such that the display complies with those standards.

Patent Document 1: JP-A-2003-215349

Patent Document 2: JP-A-2003-95390

Patent Document 3: JP-T-2003-532153

Since the LEDs (R), (G), and (B) undergo relatively great variation during manufacture, emission peak wavelengths of the LEDs can vary in the range from about ±5 to about ±10 nm from design values in general. Since backlight units 106 consequently vary in chromaticity, a problem arises in that some liquid crystal displays 101 may be manufactured out of the standards even though they are designed to comply with the standards. One solution is to manufacture backlight units 106 with the emission peak wavelengths of the LEDs (R), (G), and (B) properly controlled. In this case, for example, there is a need for a screening operation to pick up LEDs emitting beams of light having predetermined emission peak wavelengths out of all LEDs which are supposed to be used. Since LEDs out of standards for emission peak wavelengths are not usable as light sources of a backlight unit 106, a problem arises in that it is difficult to obtain a sufficient quantity of LEDs. Therefore, in order to obtain a sufficient quantity of LEDs to meet the quantity of backlight units 106 to be manufactured, LEDs must be prepared in a quantity greater than the quantity that is required. For this reason, a problem arises in that the unit cost of the LEDs becomes very high. Consequently, there is a problem in that the costs of a backlight unit 106 and a liquid crystal display 101 also increase.

### SUMMARY OF THE INVENTION

It is an object of the invention to provide a low-cost surface illuminator and a liquid crystal display having the same.

The above-described object is achieved by a surface illuminator characterized in that it includes a light exit region from which light in a color reproduction range defined by a plurality of chromaticities exits; a light guide region for guiding light to the light exit region; a first group of light sources emitting light toward the light guide region, the light having a wavelength shorter than a desired wavelength λ0 providing a chromaticity X that is one of the plurality of chromaticities; a second group of light sources emitting light toward the light guide region, the light having a wavelength longer than the desired wavelength λ0; a first driving portion for driving the first group of light sources; and a second driving portion for driving the second group of light sources.

The invention makes it possible to provide a low-cost surface illuminator and a liquid crystal display having the same.

### BRIEF DESCRIPTION OF THE DRAWINGS

FIG. 1 is an x-y chromaticity diagram representing a color reproduction range of a surface illuminator in a mode for carrying out the invention;

FIG. 2 shows emission spectra of beams of light from the surface illuminator in the mode of carrying out the invention, the emission spectra allowing the three chromaticities shown in FIG. 1 to be achieved respectively;

FIGS. 3A and 3B show a schematic structure of a liquid crystal display 1 having a backlight unit 6 according to Embodiment 1 in the mode for carrying out the invention;

FIG. 4 is a circuit block diagram of a light source driving circuit 17 provided in the backlight unit 6 according to Embodiment 1 in the mode for carrying out the invention;

FIG. 5 shows emission spectra of beams of light emitted by LED light sources 15 provided at the backlight unit 6 according to Embodiment 1 in the mode for carrying out the invention;

FIG. 6 is an x-y chromaticity diagram showing a color reproduction range of the backlight unit 6 in the mode for carrying out the invention;

FIG. 7 is an exploded perspective view of a backlight unit 26 according to Embodiment 2 in the mode for carrying out the invention;

FIG. 8 shows driving conditions for color reproduction ranges A and B which can be provided by a backlight unit according to Embodiment 3 in the mode for carrying out the invention;

FIG. 9 is a circuit block diagram of a light source driving circuit provided in the backlight unit according to Embodiment 3 in the mode for carrying out the invention; and

FIGS. 10A and 10B show schematic structures of a backlight unit 106 and a liquid crystal display 101 having the same according to the related art.

### DESCRIPTION OF THE PREFERRED EMBODIMENTS

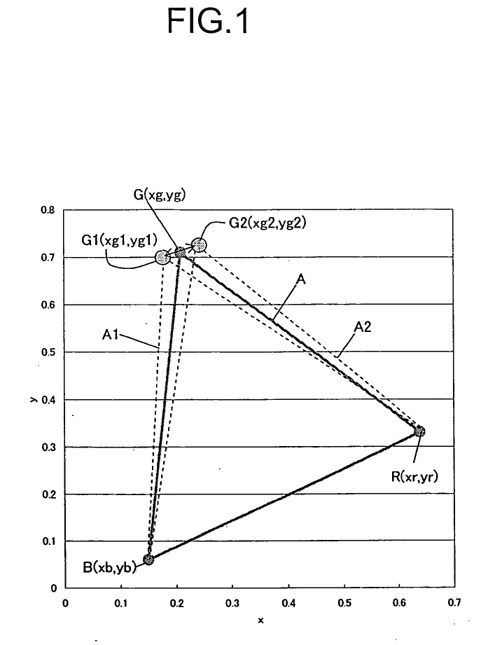

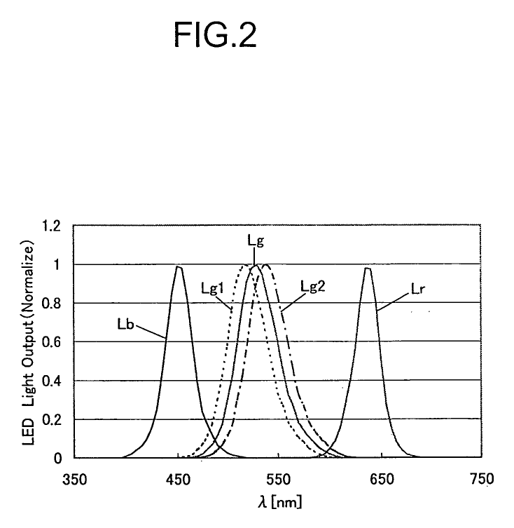

A description will now be made with reference to FIGS. 1 to 9 on a surface illuminator and a liquid crystal display having the same in a mode for carrying out the invention. First, a description will be made with reference to FIGS. 1 and 2 on a basic principle for adjustment of variations of chromaticity in the surface illuminator in the present mode for carrying out the invention. FIG. 1 is an x-y chromaticity diagram representing a color reproduction range defined by three chromaticities. The abscissa axis represents chromaticity coordinates x, and the ordinate axis represents chromaticity coordinates y. FIG. 2 shows the emission spectra of beams of light which provide the three chromaticities shown in FIG. 1, respectively. The abscissa axis represents wavelengths λ (nm), and the ordinate axis represents the light outputs of the LEDs emitting the beams of light. In FIG. 2, the light outputs of the LEDs are normalized to a maximum value of 1.

As shown in FIG. 1, a color reproduction range A is defined by, for example, red (R), green (G), and blue (B) chromaticities. In FIG. 1, for example, the chromaticity coordinates of the red chromaticity (chromaticity R) is (xr, yr), the chromaticity coordinates of the green chromaticity (chromaticity G) is (xg, yg); and the chromaticity coordinates of the blue chromaticity (chromaticity B) is (xb, yb). As shown in FIG. 2, red light (R light) Lr that provides the chromaticity R has an emission peak wavelength λR0; green light (G light) Lg that provides the chromaticity G has an emission peak wavelength λG0; and blue light (B light) Lb that provides the chromaticity B has an emission peak wavelength λB0.

A basic principle of chromaticity adjustment will now be described with reference to the chromaticity G by way of example. Two LEDs (first and second G-emission LEDs) which are categorized in advance based on their emission peak wavelength are used as light sources to achieve the chromaticity G. The first G-emission LED emits G light Lg1 having a wavelength shorter than the emission peak wavelength λG0 which results in the target chromaticity G, and the second G-emission LED emits G light Lg2 having a wavelength longer than the emission peak wavelength λB0.

Let us assume that the chromaticity coordinates of a chromaticity G1 obtained by the G light Lg1 having a short wavelength are (xg1, yg1) as shown in FIG. 1. Then, a color reproduction range A1 is defined by the chromaticity R, the chromaticity G1, and the chromaticity B as indicated by a broken line in the figure. Let us assume that the chromaticity coordinates of a chromaticity G2 obtained by the G light Lg2 having a long wavelength are (xg2, yg2). Then, a color reproduction range A2 is defined by the chromaticity R, the chromaticity G2, and the chromaticity B as indicated by another broken line in the figure. The resultant green on the light exit surface of the surface illuminator will be a color that is a mixture of the G light Lg1 and the G light Lg2 and will depend on the quantity of each of the G light beams Lg1 and Lg2. When the ratio between the quantities of the G light beams Lg1 and Lg2 is changed, any of chromaticities residing on a substantially straight line connecting the chromaticity coordinates of the G light beams Lg1 and Lg2 will be obtained. Since the quantities of the G light beams Lg1 and Lg2 are substantially proportionate to the currents driving the first and second G-emission LEDs, the visually perceived chromaticity can be made substantially coincide with the target chromaticity G by adjusting the currents to optimize the quantity of each of the G light beams Lg1 and Lg2.

For example, when the driving current for the second G-emission LED is nullified to set the ratio of the driving current for the first G-emission LED to the driving current for the second G-emission LED at 100%:0%, the color of green on the light exit surface will have the chromaticity (chromaticity coordinates) of the G light provided by the first G-emission light LED. When the driving current for the first G-emission LED is nullified to set the ratio of the driving current for the first G-emission LED to the driving current for the second G-emission LED at 0%:100%, the color of green will have the chromaticity (chromaticity coordinates) of the G light provided by the second G-emission LED. When the ratio between the driving currents for the first and second G-emission LEDs is varied as thus described, the chromaticity of the green will move between two points, i.e., the chromaticity coordinates (xg1, yg1) of the G light Lg1 and the chromaticity coordinates (xg2, yg2) of the G light Lg2.

Let us now assume that (x1, y1) and L1 respectively represent the chromaticity coordinates and the quantity of light having a wavelength shorter than a desired wavelength λ0 resulting in a chromaticity X (chromaticity coordinates (x0, y0)) which is any of a plurality of chromaticities defining a target color reproduction range and that (x2, y2) and L2 respectively represent the chromaticity coordinates and the quantity of light having a wavelength longer than the desired wavelength λ0. Then, the chromaticity coordinates (x3, y3) and the quantity (L3) of light in a composite color obtained by as a result of color mixing between the light having a shorter wavelength and the light having a longer wavelength can be obtained as follows.
X3=(x1×L1/y1+x2×L2/y2)/(L1/y1+L2/y2) Expression 1
y3= (y1×L1/y1+y2×L2/y2)/(L1/y1+L2/y2) Expression 2
L3=L1+L2 Expression 3

As indicated by Expressions 1 and 2, the chromaticity coordinates (x3, y3) of the composite color can be changed by changing the quantity L1 of the light having a shorter wavelength and the quantity L2 of the light having a longer wavelength. Since the quantities of light L1 and L2 are substantially proportionate to the amounts of the driving currents, the chromaticity coordinates (x3, y3) of the composite color can be made substantially coincide with the chromaticity coordinates (x0, y0) of the target chromaticity X. Further, the chromaticity of light exiting the surface illuminator after the chromaticity adjustment or the chromaticity provided by combining the beams of light having a plurality of chromaticities can be made to substantially coincide with the target chromaticity by setting the quantities of light L1 and L2 having the two wavelengths such that the quantity L3 of the light in the composite color substantially equals the quantity of light having the target chromaticity X.

A more specific description will be made below with reference to embodiments of the invention.

### Embodiment 1

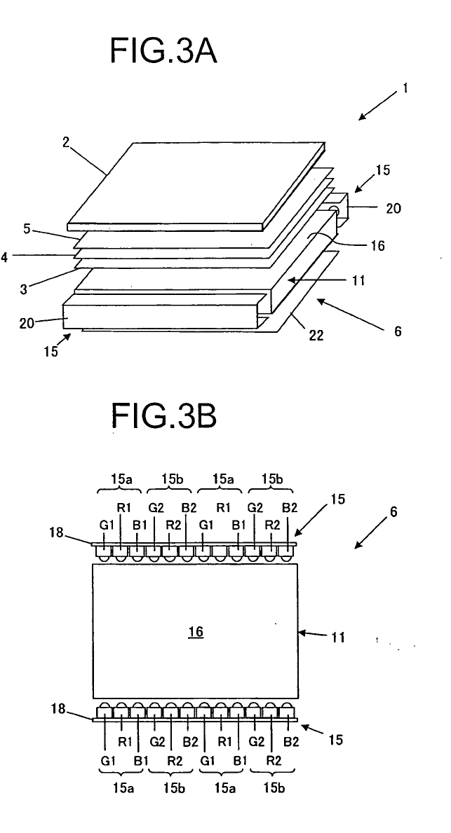

First, a description will be made with reference to FIGS. 3A to 6 on a backlight unit as a surface illuminator and a liquid crystal display having the same according to Embodiment 1 of the invention. FIGS. 3A and 3B show a schematic structure of a liquid crystal display 1 having a side lighting type backlight unit 6 according to the present embodiment. FIG. 3A is an exploded perspective view of the liquid crystal display 1, and FIG. 3B is a view of the backlight unit 6 taken from a light emitting side thereof. As shown in FIG. 3A, the liquid crystal display 1 includes a liquid crystal display panel 2 provided by sealing a liquid crystal between a pair of substrates and the backlight unit 6 serving as a surface illuminator.

The backlight unit 6 has a light guide 11 constituted by a transparent member in the form of a rectangular thin plate having a predetermined thickness. The light guide 11 has a light exit region (hereinafter referred to as light exit surface) 16 which spreads in the form of a plane on a side thereof facing the liquid crystal display panel 2 to allow light to exit. Light in a color reproduction range defined by a plurality of (three in the present embodiment) chromaticities exits from the light exit surface 16. A surface of the light guide 11 opposite to the light exit surface 16 is a light scattering surface on which scattering dots (not shown) serving as a light output portion are printed. A reflective sheet 22 is provided on the light scattering surface of the light guide 11 opposite to the light exit surface 16.

A region of the light guide 11 sandwiched between the light exit surface 16 and the light scattering surface opposite thereto constitutes a light guide region for guiding light to the light exit surface 16. Among four side portions surrounding the peripheries of the light exit surface 16 and the light scattering surface, two side surfaces opposite to each other, e.g., the side surfaces along the longer sides of the light guide constitute light entrance surfaces through which light enters the light guide region.

LED light sources 15, which are arrays of discrete light sources provided by linearly arranging LEDs emitting R light, G light, and B light, are provided opposite to light entrance surfaces of the light guide 11. As shown in FIG. 3B, the LED light sources 15 include a plurality of first light source groups 15a emitting light having a wavelength shorter than a desired wavelength toward the light guide region, a plurality of second light source groups 15b emitting light having a wavelength longer than a desired wavelength toward the light guide region, and an LED mounting substrate 18 on which the first and second light source groups 15a and 15b are mounted. The first and second light source groups 15a and 15b are provided on two side edges of the light exit surface 16.

A color filter is provided at each pixel of the liquid crystal display panel 2. The chromaticity of each of red light (R light), green light (G light), and blue light (B light) transmitted by the liquid crystal display panel 2 is determined substantially by the combination of the emission spectrum of the light emitted from the backlight unit 6 and the transmission characteristics of the color filters of the liquid crystal display panel 2 associated therewith. Light having the above-mentioned desired wavelength has an emission spectrum which allows a target chromaticity to be achieved on the display screen of the liquid crystal display panel 2. For example, the desired wavelength is a peak emission wavelength of the emission spectrum. Alternatively, the desired wavelength may be a wavelength dominant in the emission spectrum. Referring to the LEDs used as the LED light sources 15, for example, the emission spectra and emission peak wavelengths of light emitted by the LEDs are measured in advance to categorize them into the first light source groups 15a which emit light having an emission peak wavelength shorter than the desired wavelength and the second light source groups 15b which emit light having a wavelength longer than the desired wavelength. Further, the first and second light source groups 15a and 15b include LEDs which emit R light, G light, and B light.

The first light source groups 15a include first R-emission LEDs (R1) emitting R light having a wavelength shorter than a desired wavelength λR0 at which a target chromaticity of red is achieved, first G-emission LEDs (G1) emitting G light having a wavelength shorter than a desired wavelength λG0 at which a target chromaticity of green is achieved, and first B-emission LEDs (B1) emitting B light having a wavelength shorter than a desired wavelength λB0 at which a target chromaticity of blue is achieved. For example, the first R-emission LEDs (R1), the first G-emission LEDs (G1), and the first B-emission LEDs (B1) are arranged such that LEDs of different colors adjoin each other.

Similarly, the second light source groups 15b include second R-emission LEDs (R2) emitting R light having a wavelength longer than the desired wavelength λR0, second G-emission LEDs (G2) emitting G light having a wavelength longer than the desired wavelength λG0, and second B-emission LEDs (B2) emitting B light having a wavelength longer than the desired wavelength λB0. For example, the second R-emission LEDs (R2), the second G-emission LEDs (G2), and the second B-emission LEDs (B2) are arranged such that LEDs of different colors adjoin each other. For example, LEDs of different colors are provided in a region where a first light source group 15a and a second light source group 15b adjoin each other.

The LEDs belonging to the first and second light source groups 15a and 15b are disposed substantially in line along the light entrance surfaces of the light guide 11. Reflectors (reflective plates) 20 (not shown in FIG. 3B) are provided around the LED light sources 15 to allow light from the LED light sources 15 to enter the light guide 11 efficiently.

A diffusing sheet 3 and two lens sheets 4 and 5 are provided in the order listed between the light guide 11 and the liquid crystal display panel 3. As thus described, the backlight unit 6 has a configuration in which the reflective sheet 22, the light guide 11, the diffusing sheet 3, and the two lens sheets 4 and 5 are provided one over another in the order listed.

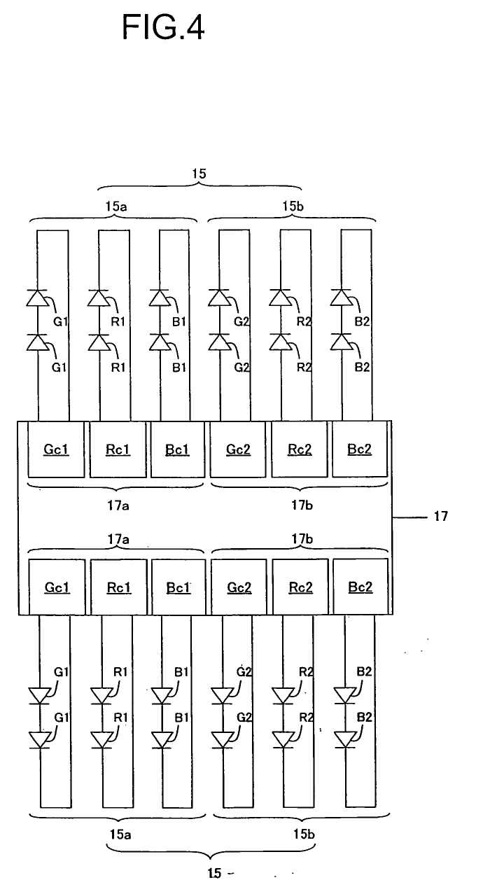

FIG. 4 is a circuit block diagram of a light source driving circuit 17 for driving the LED light sources 15. As shown in FIG. 4, the light source driving circuit 17 includes first driving portions 17a for driving the first light source groups 15a and second driving portions 17b for driving the second light source groups 15b. The first and second driving portions 17a and 17b are driven independently of each other such that drive currents for driving the first and second light source groups 15a and 15b can be adjusted separately. In the present embodiment, the first and second driving portions 17a and 17b are provided for each of the groups of LED light sources 15 disposed on both ends of the light exit surface 16 to allow highly accurate adjustment of the chromaticity of light exiting the light exit surface 16 of the light guide 11. However, the invention is not limited to such an arrangement. For example, the first and second driving portions 17a and 17b may be provided so as to serve the LED light sources 15 disposed on both ends of the light exit surface 16 of the light guide 11 commonly.

A first driving portion 17a includes a first R driving circuit Rc1 for driving a first R-emission LED (R1), a first G driving circuit Gc1 for driving a first G-emission LED (G1), and a first B driving circuit Bc1 for driving a first B-emission LED (B1). The driving circuits Rc1, Gc1, and Bc1 are driven independently of each other such that drive currents for driving the respective LEDs (R1), (G1), and (B1) can be adjusted separately. For example, the driving circuits Rc1, Gc1, and Bc1 are constant current circuits.

A second driving portion 17b includes a second R driving circuit Rc2 for driving a second R-emission LED (R2), a second G driving circuit Gc2 for driving a second G-emission LED (G2), and a second B driving circuit Bc2 for driving a second B-emission LED (B2). The driving circuits Rc2, Gc2, and Bc2 are driven independently of each other such that drive currents for driving the respective LEDs (R2), (G2), and (B2) can be adjusted separately. For example, the driving circuits Rc2, Gc2, and Bc2 are constant current circuits.

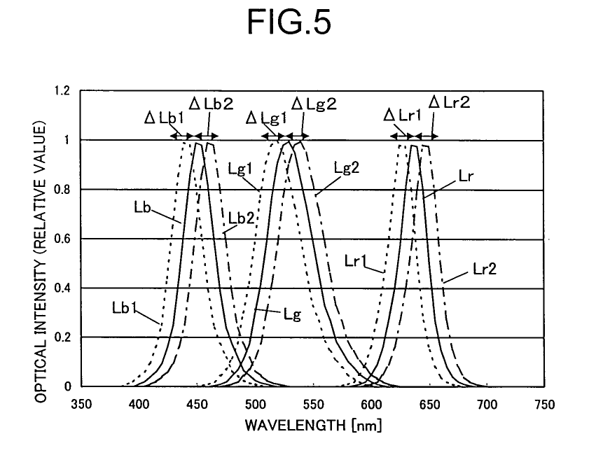

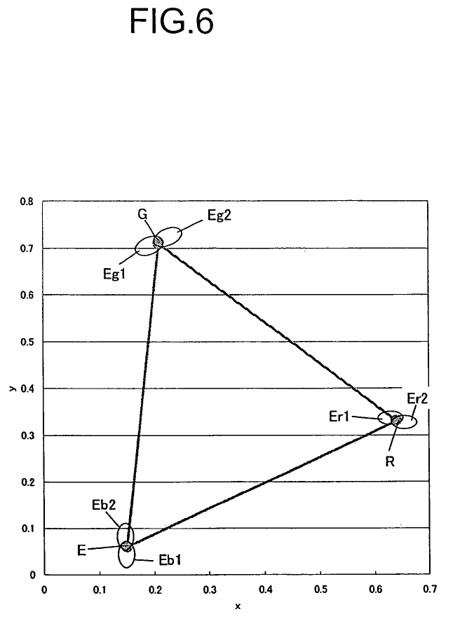

FIG. 5 shows emission spectra of the LEDs (R1), (G1), (B1), (R2), (G2), and (B2) included in the LED light sources 15 and emission spectra of beams of light which provide the target chromaticities R, G, and B, respectively. The abscissa axis represents wavelengths (nm), and the ordinate axis represents optical intensities (relative values) of the beams. In FIG. 5, the optical intensities are normalized to a maximum value of 1. FIG. 6 is an x-y chromaticity diagram representing a target color reproduction range for the backlight unit 6 of the present embodiment. The abscissa axis represents chromaticity coordinates x, and the ordinate axis represents chromaticity coordinates y.

As shown in FIG. 5, the first R-emission LEDs (R1) emit light Lr1 having a wavelength shorter than that of light Lr which provides the target chromaticity R. Beams of light emitted by all of the first R-emission LEDs (R1) included in the LED light sources 15 do not have the same wavelength, and there may be variations within a predetermined range of wavelengths ΔLr1. Therefore, the beams of light emitted by all of the first R-emission LEDs (R1) are a monochromatic beam group (monochromatic beam group a) ar constituted by a plurality of monochromatic beams of light. An average wavelength λR1 that is an average of the wavelengths of the plurality of monochromatic beams constituting the monochromatic beam group ar is shorter than the desired wavelength λR0. The monochromatic beam group ar includes monochromatic beams having a wavelength substantially equal to the desired wavelength λ0. Therefore, as shown in FIG. 6, chromaticity reproduced on the light exit surface 16 by R light emitted by the first R-emission LEDs (R1) is represented by chromaticity coordinates within a region Er1 including the target chromaticity R.

Similarly, as shown in FIG. 5, the second R-emission LEDs (R2) emit light Lr2 having a wavelength longer than that of the light Lr which provides the target chromaticity R. Beams of light emitted by all of the second R-emission LEDs (R2) included in the LED light sources 15 do not have the same wavelength, and there may be variations within a predetermined range of wavelengths ΔLr2. Therefore, the beams of light emitted by all of the second R-emission LEDs (R2) are a monochromatic beam group (monochromatic beam group β) βr constituted by a plurality of monochromatic beams of light. An average wavelength λR2 that is an average of the wavelengths of the plurality of monochromatic beams constituting the monochromatic beam group βr is longer than the desired wavelength λR0. The monochromatic beam group βr includes monochromatic beams having a wavelength substantially equal to the desired wavelength λ0. Therefore, as shown in FIG. 6, chromaticity reproduced on the light exit surface 16 by R light emitted by the second R-emission LEDs (R2) is represented by chromaticity coordinates within a region Er2 including the target chromaticity R.

As shown in FIG. 5, the description on the first and second R-emission LEDs (R1) and (R2) applies to light Lg1 having a shorter wavelength emitted by the first G-emission LEDs (G1) and light Lg2 having a longer wavelength emitted by the second G-emission LEDs (G2). Therefore, as shown in FIG. 6, chromaticity provided by the beams of light Lg1 (a monochromatic beam group αg) having a shorter wavelength emitted by the plurality of first G-emission LEDs (G1) respectively is represented by chromatic coordinates within a region Eg1 including the target chromaticity G, and chromaticity provided by the beams of light Lg2 (a monochromatic beam group βg) having a longer wavelength emitted by the plurality of second G-emission LEDs (G2) respectively is represented by chromatic coordinates within a region Eg2 including the target chromaticity G.

As shown in FIG. 5, the description on the first and second R-emission LEDs (R1) and (R2) applies to light Lb1 having a shorter wavelength emitted by the first B-emission LEDs (B1) and light Lb2 having a longer wavelength emitted by the second B-emission LEDs (B2). Therefore, as shown in FIG. 6, chromaticity provided by the beams of light Lb1 (a monochromatic beam group ab) having a shorter wavelength emitted by the plurality of first B-emission LEDs (B1) respectively is represented by chromatic coordinates within a region Eb1 including the target chromaticity B, and chromaticity provided by the beams of light Lb2 (a monochromatic beam group βb) having a longer wavelength emitted by the plurality of second B-emission LEDs (B2) respectively is represented by chromatic coordinates within a region Eb2 including the target chromaticity B.

Each of the first and second R driving circuits Rc1 and Rc2, the first and second G driving circuits Gc1 and Gc2, and the first and second B driving circuits Bc1 and Bc2 can be independently driven. Therefore, the light outputs of the LEDs (R1), (R2), (G1), (G2), (B1), and (B2) can be adjusted by changing the drive currents output by the circuits Rc1, Rc2, Gc1, Gc2, Bc1, and Bc2 respectively. The chromaticity of each of red, green, and blue on the display screen of the liquid crystal display panel 2 changes based on Expressions 1 and 2. As a result, the chromatic coordinates of those colors can be made to substantially coincide with the chromatic coordinates of the target chromaticities R, G, and B.

The sum of the quantities of beams emitted by the first and second R-emission LEDs (R1) and (R2) respectively is adjusted so that it substantially agrees with the quantity of light at which the target chromaticity R is achieved. The sum of the quantities of beams emitted by the first and second G-emission LEDs (G1) and (G2) respectively is adjusted so that it substantially agrees with the quantity of light at which the target chromaticity G is achieved. The sum of the quantities of beams emitted by the first and second B-emission LEDs (B1) and (B2) respectively is adjusted so that it substantially agrees with the quantity of light at which the target chromaticity B is achieved. By adjusting the quantities of R, G, and B beams while maintaining the ratio between the quantities of beams from the LEDs R1 and R2, the ratio between the quantities of beams from the LEDs G1 and G2, and the ratio between the quantities of beams from the LEDs B1 and B2 adjusted as described above, white balance of the display screen after the adjustment on each chromaticity can be made to substantially coincide with target white balance.

In the present embodiment, each of the monochromatic beams groups αr, βr, αg, βg, αb, and βb includes beams of light which provide the target chromaticity, and each of the regions Er1, Er2, Eg1, Eg2, Eb1, and Eb2 respectively includes the target chromaticity. The regions Er1 and Er2 partially overlap each other. The regions Eg1 and Eg2 partially overlap each other. The regions Eb1 and Eb2 partially overlap each other. However, the backlight unit 6 according to the present embodiment is not limited to such a configuration. The regions Er1, Er2, Eg1, Eg2, Eb1, and Eb2 are not required to include the target chromaticities, and each of the couple of regions Er1 and Er2, the couple of regions Eg1 and Eg2, and the couple of regions Eb1 and Eb2 may have chromaticity ranges apart from each other.

In the present embodiment, the first and second light source groups 15a and 15b are alternately disposed at each of the LED light sources 15 provided opposite to each other. The first and second light source groups 15a and 15b are disposed in such a manner in order to allow R light, G light, and B light which have entered the light guide 11 to be sufficiently mixed with each other in the light guide region. The first and second light source groups 15a and 15b are not limited to such a way of disposition. For example, the LEDs may be mounted and wired to the LED mounting substrate 18 with the first light source groups 15a consecutively disposed from the right end of the LED mounting substrate 18 in FIG. 3B up to the center of the substrate and the second light source groups 15b consecutively disposed from the left end in the figure up to the center of the substrate. In disposing the LED light sources 15 opposite to each other, a configuration may be employed in which only the first light source groups 15a are disposed as one of the LED light sources 15 and only the second light source groups 15b are disposed as the other light sources.

Although a first R-emission LED (R1) is disposed adjacent to a first G-emission LED (G1) and a first B-emission LED (B1) in the present embodiment, it may alternatively be disposed adjacent to a second R-emission LED (R2), a second G-emission LED (G2) or a second B-emission LED (B2). Similarly, although a second R-emission LED (R2) is disposed adjacent to a second G-emission LED (G2) and a second B-emission LED (B2), it may alternatively be disposed adjacent to a first R-emission LED (R1), a first G-emission LED (G1) or a first B-emission LED (B1).

Further, although the first and second light source groups 15a and 15b of the present embodiment are disposed such that different colors adjoin each other, the invention is not limited to such a configuration. For example, a first light source group 15a may include a first R-emission LED group that is a set of a plurality of first R-emission LEDs (R1), a first G-emission LED group that is a set of a plurality of first G-emission LEDs (G1), and a first B-emission LED group that is a set of a plurality of first B-emission LEDs (B1), and the first R-emission LED group, the first G-emission LED group, and the first B-emission LED group may be disposed such that different colors adjoin each other. Similarly, a second light source group 15b may include a second R-emission LED group that is a set of a plurality of second R-emission LEDs (R2), a second G-emission LED group that is a set of a plurality of second G-emission LEDs (G2), and a second B-emission LED group that is a set of a plurality of second B-emission LEDs (B2), and the second R-emission LED group, the second G-emission LED group, and the second B-emission LED group may be disposed such that different colors adjoin each other.

A first R-emission LED group, first G-emission LED group, and first B-emission LED group may be disposed adjacent to a second R-emission LED group, second G-emission LED group or second B-emission LED group. For example, a first R-emission LED group, a second R-emission LED group, a first G-emission LED group, a second G-emission LED group, a first B-emission LED group, and a second B-emission LED group may be arranged in the order listed, and the arrangement may be repeated.

As described above, according to the present embodiment, even when there is variation in wavelength characteristics of beams of light output by the LEDs used in the LED light sources 15, the quantity of light emitted by each LED can be optimized by adjusting the driving current for the LED, which allows the chromaticity of each of red, green, and blue to be adjusted to a target chromaticity. As thus described, the backlight unit 6 and the liquid crystal display 1 utilizing the same according to the present embodiment can achieve a required range of chromaticity utilizing variation in wavelength characteristics of the LEDs. What is required is therefore only to perform screening to separate LEDs emitting light having wavelength shorter than a wavelength that provides a target chromaticity from LEDs emitting light having a wavelength longer than the same. There is no particular need for using LEDs having specified wavelength characteristics. Since it is possible to use all LEDs which have been supposed to be used, LEDs will suffice if they are provided just in the number as needed. Therefore, the unit cost of the LEDs becomes low, the cost of a backlight unit 6 and a liquid crystal display having the same can be reduced. Further, not only LEDs emitting light having a wavelength that provides a target chromaticity, but also all LEDs emitting light having wavelengths different from that wavelength can be used. Therefore, LEDs can be easily prepared in a required quantity. Since a color reproduction range on the display screen can be changed according to the purpose, the liquid crystal display 1 can be used in a wide range of application.

### Embodiment 2

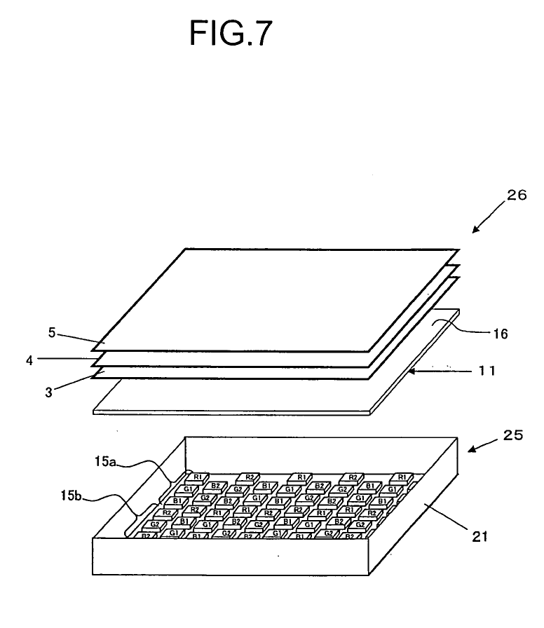

A description will now be made with reference to FIG. 7 on a backlight unit as a surface illuminator and a liquid crystal display according to Embodiment 2 in the present mode for carrying out the invention. FIG. 7 is an exploded perspective view of a backlight unit 26 of the present embodiment. As shown in FIG. 7, the backlight unit 26 of the present embodiment is characterized in that it has a direct backlight structure in which an LED light source 25 is provided on a bottom side of a light exit surface 16 of a light guide 11. The LED light source 25 includes a first light source group 15a emitting light having a wavelength shorter than a desired wavelength toward a light guide region and a second light source group 15b emitting light having a wavelength longer than the desired wavelength toward the light guide region. The first and second light source groups 15a and 15b are provided in a lamp house 21 which is formed like a thin rectangular box and which is open on the side of the light exit surface. The first and second light source groups 15a and 15b are disposed at random in a plane that is substantially in parallel with a bottom side (light-scattering surface) of the light exit surface 16. The first light source group 15a is constituted by all of first R-emission LEDs (R1), all of first G-emission LEDs (G1), and all of first B-emission LEDs (B1) disposed in the lamp house 21. The second light source group 15b is constituted by all of second R-emission LEDs (R2), all of second G-emission LEDs (G2), and all of second B-emission LEDs (B2) disposed in the lamp house 21.

Each of the first R-emission LEDs (R1), the first G-emission LEDs (G1), and the first B-emission LEDs (B1) constituting the first light source group 15a and the second R-emission LEDs (R2), the second G-emission LEDs (G2), and the second B-emission LEDs (B2) constituting the second light source group 15b may be driven independently to adjust the quantity of light emitted by each of the LEDs, whereby the chromaticity of each color can be substantially made to coincide with a target chromaticity. As thus described, the backlight unit 26 and the liquid crystal display having the same in the present embodiment can provide the same advantage as that of the above-described embodiment.

### Embodiment 3

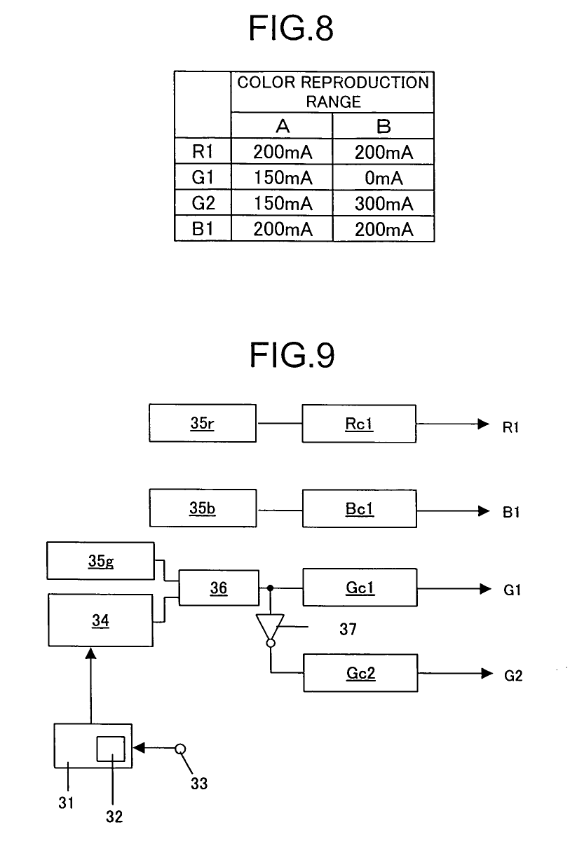

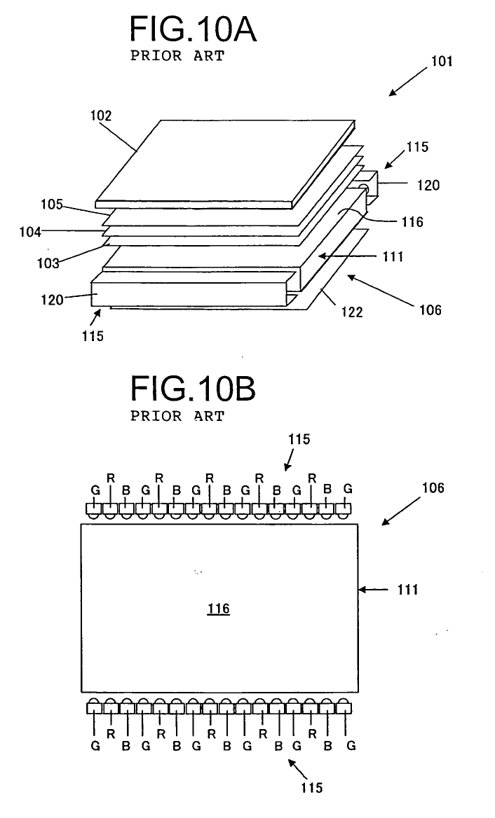

A description will now be made with reference to FIGS. 8 and 9 on a backlight unit as a surface illuminator and a liquid crystal display having the same according to Embodiment 3 in the present mode for carrying out the invention. The backlight unit of the present embodiment is characterized in that it can provide two types of color reproduction ranges. The backlight unit and the liquid crystal display having the same according to the present embodiment may have schematic configurations according to either of Embodiments 1 and 2 described above. However, it should be noted that the present embodiment is an example in which only the chromaticity of green is adjusted and that LEDs emitting beams of light having a short wavelength and a long wavelength (first and second G-emission LEDs (G1) and (G2)) are required for at least G light.

FIG. 8 shows driving conditions for color reproduction ranges A and B which can be provided by the backlight unit of the present embodiment. As shown in FIG. 8, differences in driving conditions for LED light sources for providing the color reproduction ranges A and B reside only the first and second G-emission LEDs (G1) and (G2). A driving current of 150 mA is set for the first and second G-emission LEDs (G1) and (G2) to provide the color reproduction range A, whereas driving currents of 0 mA and 300 mA are set for the first and second G-emission LEDs (G1) and (G2), respectively, to provide the color reproduction range B.

FIG. 9 is circuit block diagram of a light source driving circuit provided in the backlight unit of the present embodiment. As shown in FIG. 9, the light source driving circuit includes a storage portion 32 in which the color reproduction ranges A and B are stored, a selection signal input portion 33 to which a selection signal used for selection between the color reproduction ranges A and B is input, and a control portion 31 which controls driving conditions for first and second driving portions based on the selection signal input. In the present embodiment, since the quantities of beams emitted by the first and second G-emission LEDs (G1) and (G2) are adjusted, the control portion 31 controls driving conditions for a first G driving circuit Gc1 provided in the first driving portion and a second G driving circuit Gc2 provided in the second driving portion. While the storage portion 32 of the present embodiment is incorporated in the control portion 31, the storage portion may be a circuit separate from the control portion 31.

The light source driving circuit includes a current control signal generating portion 34 which outputs current control signals used for controlling the values of currents output by the first and second G driving circuits Gc1 and Gc2 and a pulse width modulation (PWM) circuit portion 35g which outputs a lighting control signal used for controlling lighting of the display screen of the liquid crystal panel as a whole. Further, the light source driving circuit includes an arithmetic circuit portion 36 which performs arithmetic operations of signals output by the current control signal generating portion 34 and the PWM circuit portion 35g, respectively, and an inversion circuit portion 37 which inverts a signal output by the arithmetic circuit portion 36 and outputs the resultant signal to the second G driving circuit Gc2.

Furthermore, the light source driving circuit includes a first R driving circuit Rc1 which outputs a driving current for first R-emission LEDs (R1) and a PWM circuit portion 35r which outputs a lighting control signal. The light source driving circuit also includes a first B driving circuit Bc1 which outputs a driving current for first B-emission LEDs (B1) and a PWM circuit portion 35b which outputs a lighting control signal. The luminance of the display screen is at the maximum when pulse signals output by the PWM circuit portions 35r, 35g, and 35b have a duty ratio of 100% (a DC signal).

Operations of the light driving circuit will now be described. For example, the liquid crystal display is provided with a selection switch for selecting the color reproduction range A or B to allow a user to select the color reproduction range A or B as desired by operating the selection switch. Let us assume now, for example, that the user has selected the color reproduction range A. Then, a signal indicating that the color reproduction range A has been selected is input to the control portion 31 through the selection signal input portion 33. The control portion 31 reads the driving conditions for the first and second G driving circuits Gc1 and Gc2 to be satisfied to provide the color reproduction range A and controls the current control signal generating portion 34 such that it will output a current control signal having a duty ratio of, for example, 50%.

As a result, a current control signal having a duty ratio of 50% is output from the current control signal generating portion 34 to the arithmetic circuit portion 36. Incidentally, a lighting control signal has been input from the PWM circuit portion 35g to the arithmetic circuit portion 36. The arithmetic circuit portion 36 performs an arithmetic operation on the lighting control signal and the current control signal to output an arithmetic signal. The arithmetic signal is input to the first G driving circuit Gc1 and the inversion circuit portion 37. The first G driving circuit Gc1 outputs a current of 150 mA based on the arithmetic signal. The second G driving circuit Gc2 outputs a current of 150 mA based on the inversion signal of the arithmetic signal. The quantities of beams of light emitted by the first and second G-emission LEDs (G1) and (G2) can be thus adjusted to make the chromaticity of green substantially coincide with the target chromaticity.

When the user selects the color reproduction range B, the control portion 31 controls the current control signal generating portion 34 such that it outputs a current control signal which is a direct current. The signals controlling the first and second G driving circuits Gc1 and Gc2 are signals whose phases are inverted by 180° from each other. Therefore, the currents output by the first G driving circuit Gc1 and the second G driving circuit Gc2 can be set at, for example, 0 mA and 300 mA, respectively by outputting a DC signal from the PWM circuit portion 35g. The circuit configuration of the light source driving circuit in the present embodiment is not limited to this configuration.

As described above, in the case of the backlight unit and the liquid crystal display having the same in the present embodiment, the color reproduction ranges provided on the display screen can be easily switched. The liquid crystal display can therefore be used in a wide variety of applications.

The invention is not limited to the above-described mode for carrying out the same and may be modified in various ways.

While the chromaticity of each of red, green, and blue is adjusted in the above-described mode for carrying out the invention, the invention is not limited to such an arrangement. The same advantage as in the above-described mode for carrying out the invention can be achieved, for example, in an arrangement in which the chromaticity of only any one or two of the colors red, green, and blue can be adjusted. In particular, since the chromaticity coordinates of red are subjected to small fluctuations when there are wavelength changes in the emission spectrum, the same advantages as that in the above-described mode for carrying out the invention can be achieved by adjusting only green and blue.

While the LED light sources 15 and 25 in the above-described mode for carrying out the invention are categorized into the first and second light source groups 15a and 15b, the invention is not limited to such a mode of implementation. The LED light sources 15 and 25 may have LED light source groups belonging to three or more categories. For example, a backlight unit may include an LED light source having a third group of LEDs which can substantially achieve a target chromaticity and a third driving portion for driving the third LED group in addition to the first and second light source groups 15a and 15b. In this case, a driving current can be sufficiently passed through all LEDs that constitute the third LED group within a tolerance, and the luminance of the display screen can therefore be maintained easily.

What is claimed is:

1. A surface illuminator comprising:
a light exit region from which light in a color reproduction range defined by a plurality of chromaticities exits;
a light guide region for guiding light to the light exit region;
a first group of light sources emitting light toward the light guide region, the light having a wavelength shorter than a desired wavelength λ0 providing a chromaticity X that is one of the plurality of chromaticities;
a second group of light sources emitting light toward the light guide region, the light having a wavelength longer than the desired wavelength λ0;
a first driving portion for driving the first group of light sources; and
a second driving portion for driving the second group of light sources.

2. A surface illuminator according to claim 1, wherein the quantity of each of the light having a shorter wavelength and the light having a longer wavelength is adjusted such that the chromaticity of light obtained as a result of color mixing between the light having a shorter wavelength and the light having a longer wavelength substantially equals the chromaticity X.

3. A surface illuminator according to claim 1, wherein the light having a shorter wavelength is a monochromatic beam group a constituted by a plurality of monochromatic beams of light within a predetermined range of wavelengths and wherein the light having a longer wavelength is a monochromatic beam group β constituted by a plurality of monochromatic beams of light within a range of wavelength different from the predetermined range of wavelength.

4. A surface illuminator according to claim 3, wherein an average wavelength λ1 that is an average of the wavelengths of the plurality of monochromatic beams of light constituting the monochromatic beam group α is shorter than the desired wavelength λ0.

5. A surface illuminator according to claim 3, wherein at least one of the wavelengths of the plurality of monochromatic beams of light constituting the monochromatic beam group a is substantially equal to the desired wavelength λ0.

6. A surface illuminator according to claim 3, wherein an average wavelength λ2 that is an average of the wavelengths of the plurality of monochromatic beams of light constituting the monochromatic beam group β is longer than the desired wavelength λ0.

7. A surface illuminator according to claim 3, wherein at least one of the wavelengths of the plurality of monochromatic beams of light constituting the monochromatic beam group β is substantially equal to the desired wavelength λ0.

8. A surface illuminator according to claim 3, wherein the wavelengths of the plurality of monochromatic beams of light constituting the respective monochromatic beam groups α and β are an emission peak wavelength or a dominant wavelength.

9. A surface illuminator according to claim 1, wherein the chromaticity X is a chromaticity of red, green, or blue.

10. A surface illuminator according to claim 1, wherein the chromaticity X is any two chromaticities among the plurality of chromaticities and wherein the two chromaticities X are chromaticities of red and green, chromaticities of the red and blue, or chromaticities of the green and the blue.

11. A surface illuminator according to claim 1, wherein the chromaticity X is any three chromaticities among the plurality of chromaticities and wherein the three chromaticities X are chromaticities of red, green, and blue.

12. A surface illuminator according to claim 9, wherein the first group of light sources includes at least any one of:
a first R-emission LED emitting red light having a wavelength shorter than a desired wavelength λR0 which provides the chromaticity of red;
a first G-emission LED emitting green light having a wavelength shorter than a desired wavelength λG0 which provides the chromaticity of green; and
a first B-emission LED emitting blue light having a wavelength shorter than a desired wavelength λB0 which provides the chromaticity of blue and wherein the second group of light sources includes at least any one of:
a second R-emission LED emitting red light having a wavelength longer than the desired wavelength λR0;
a second G-emission LED emitting green light having a wavelength longer than the desired wavelength λG0; and
a second B-emission LED emitting blue light having a wavelength longer than the desired wavelength λB0.

13. A surface illuminator according to claim 12, wherein the first driving portion includes at least any one of:
a first R driving circuit for driving the first R-emission LED;
a first G driving circuit for driving the first G-emission LED; and
a first B driving circuit for driving the first B-emission LED and wherein the second driving portion includes at least any one of:
a second R driving circuit for driving the second R-emission LED;
a second G driving circuit for driving the second G-emission LED; and
a second B driving circuit for driving the second B-emission LED.

14. A surface illuminator according to claim 12, wherein:
the first group of light sources includes a plurality of the first R-emission LEDs, a plurality of the first G-emission LEDs, and a plurality of the first B-emission LEDs;
the first R-emission LED, the first G-emission LED, and the first B-emission LED are disposed such that different colors adjoin each other;
the second group of light sources includes a plurality of the second R-emission LEDs, a plurality of the second G-emission LEDs, and a plurality of the second B-emission LEDs; and
the second R-emission LED, the second G-emission LED, and the second B-emission LED are disposed such that different colors adjoin each other.

15. A surface illuminator according to claim 14, wherein the first R-emission LED, the first G-emission LED or the first B-emission LED is disposed adjacent to the second R-emission LED, the second G-emission LED or the second B-emission LED.

16. A surface illuminator according to claim 14, wherein:
the first group of light sources includes a first R-emission LED group that is a set of a plurality of the first R-emission LEDs, a first G-emission LED group that is a set of a plurality of the first G-emission LEDs, and a first B-emission LED group that is a set of a plurality of the first B-emission LEDs;
the first R-emission LED group, the first G-emission LED group, and the first B-emission LED group are disposed such that different colors adjoin each other;
the second group of light sources includes a second R-emission LED group that is a set of a plurality of the second R-emission LEDs, a second G-emission LED group that is a set of a plurality of the second G-emission LEDs, and a second B-emission LED group that is a set of a plurality of the second B-emission LEDs; and
the second R-emission LED group, the second G-emission LED group, and the second B-emission LED group are disposed such that different colors adjoin each other.

17. A surface illuminator according to claim 16, wherein the first R-emission LED group, the first G-emission LED group or the first B-emission LED group is disposed adjacent to the second R-emission LED group, the second G-emission LED group or the second B-emission LED group.

18. A surface illuminator according to claim 1, wherein the first and second groups of light sources are disposed at a side edge of the light exit surface.

19. A surface illuminator according to claim 1, wherein the first and second groups of light sources are disposed on a bottom side of the light exit surface.

20. A surface illuminator according to claim 19, wherein the first and second groups of light sources are disposed at random in a plane substantially in parallel with the bottom side of the light exit surface.

21. A surface illuminator according to claim 1, comprising:
a storage portion in which a plurality of the color reproduction ranges are stored;
a selection signal input portion to which a selection signal used for selection between the plurality of color reproduction ranges is input; and
a control portion for controlling driving conditions for the first and second driving portions based on the input selection signal.

22. A liquid crystal display comprising a liquid crystal display panel provided by sealing a liquid crystal between a pair of substrates and a surface illuminator for illuminating the liquid crystal display panel, wherein the surface illuminator is a surface illuminator according to claim 1.

23. A liquid crystal display according to claim 22, wherein the surface illuminator serves as a backlight unit.
